(19) United States
(12) Patent Application Publication
(10) Pub. No.: US 2006/0021696 A1
(43) Pub. Date: Feb. 2, 2006

(54) Process for producing plastic parts

(76) Inventors: Konrad Eipper, Rottenburg (DE); Klaus-Erik Schmd, Kirchheim (DE)

Correspondence Address: PENDORF & CUTLIFF, 5111 MEMORIAL HIGHWAY, TAMPA, FL, 33634-7356, US

(21) Appl. No.: 11/194,155

(22) Filed: Aug. 1, 2005

(30) Foreign Application Priority Data
Jul. 30, 2004 (DE) 10 2004 037 102.4
Aug. 17, 2004 (DE) 10 2004 039 751.1

(51) Int. Cl. B29C 65/00

(52) U.S. Cl. 156/196; 264/285

(57) ABSTRACT

A process for production of components of a plastic material, in particular fiber-reinforced plastic material. The component is produced starting with a device for providing plastic material to a continuous manufacturing process involving roller profiling of heated plastic material. The plastic material is assembled in the device for providing of plastic material of several different stock or semi-finished parts. At least one of the stock or semi-finished parts is made of a metallic material, in particular sheet metal.

### BACKGROUND OF THE INVENTION

1. Field of the Invention

The invention concerns a process for producing parts made of plastic, in particular a fiber reinforced plastic.

2. Related Art of the Invention

It is well known to use rollers in processing of plastics for production of planar and flat plates, bands or sheets. Examples thereof can be found in DE 101 12 296 A1 and DE 40 33 661 A1 as well as DE 41 31 394 A1, in particular for the production of so-called sandwiched sheets of multiple material layers. These sheets however represent only preforms, which later can or, as the case may be, must be further processed separately from their original manufacture. This is very labor intensive, time consuming, expensive and, in the case of certain plastics such as for example duroplastics, not possible by deforming. The processing necessary, for example, shape cutting, is associated with trimming or waste, which in particular in the case of fiber-reinforced plastics can be a health-safety concern due to the short length of the trimmed fiber. Further, in the case of shape cutting processing with fiber reinforced materials the fibers are in part cut through, which could lead to a substantial loss in stability or rigidity and a very poor surface quality.

From DE 66 07 880 U1 it is known to produce an assembly of two extruded thermoplastic sheets, in which webbing is embedded. In DE 33 20 550 A1 a process is described, in which an extruded plastic material is laminated with a film during manufacture.

From the general state of the art, reference can be made to DE 101 12 296 A1, which illustrates the production of plates or sheets of an extruded material. The material is extruded from the extruder directly between rollers, which forms it into plates or sheets.

Besides this, regarding the general state of the art reference can be made to DE 197 21 370 A1. For production of three dimensional stamped or embossed network structures, the fibers of a net-like web are melted to each other by heating. Thereafter, using appropriate rollers, the required structure of the mesh is impressed.

### SUMMARY OF THE INVENTION

It is the task of the present invention to provide a process for production of components of a plastic material, in particular a fiber reinforced plastic material, which avoids the above mentioned disadvantages, and which is suitable for the continuous manufacture of finished components.

In accordance with the invention, this task is solved by the process having the characteristics of Claim 1.

The inventive process concerns a continuous manufacturing process for plastic components. Beginning with the preparation of material, which may be carried out differently depending upon material and desired construction component, the compacting and deforming of the plastic material occurs subsequently during roller profiling. By this roller profiling—also known as roller deforming—as generally known from the field of processing of metals, the finished construction component can be produced directly from prepared materials. By the appropriate variability of the rollers participating in the roller profiling, which in accordance with a very advantageous further development of the invention can be varied with respect to their speed and their position via a control device, a large number of two-dimensional shapes can be produced. According to a preferred embodiment of the inventive process the roller profiling could include a continuous three-dimensional deforming, so that also bent or curved three-dimensional components can be produced.

In accordance with the invention, in the device for providing plastic materials, a number of raw stock or semi-finished parts, including at least one of a metallic material, are brought together with the plastic material. This makes possible for example the reinforcement of a material in the edge areas, for example by webbing with specially oriented fibers, metal sheets, plastic ropes, wires or the like. Targeted material characteristics can also be achieved by select material inserts, for example paper honeycombs as intermediate layer for carrier surfaces and sound-insulating materials. By the employment of thicker metal foils or metal sheets a particularly stable so-called hybrid component of metal and plastic can be produced, wherein the durable joining of the materials can be ensured by the interlocking or engaging in each other of partial areas, for example by the form-locking joining. In the preferred, however not the only conceivable, application such a sandwich component can be produced by the super-positioning of various layers, which are available for example from supply rolls.

The inventive continuous manufacturing process of the components by means of roller profiling occurs herein in the manner that the plastic material, during the component manufacturing process, is warmed for at least a time interval. For this, heat can be introduced during or prior to the manufacturing, so that the component is directly heated or remains warm on the basis of its latent heat storage capacity. Typically, for thermoplastic materials, the heating can occur prior to manufacturing, wherein the material is then systematically cooled and/or (re)heated during manufacturing. For duroplastic materials the heating can typically occur during and subsequent to component manufacture. Typical temperature ranges for the warm component vary depending upon the employed material, and are however typically up to 220° C. Accordingly the process according to the invention is employable with various plastic materials or, as the case may be, thermoplastic and/or duroplastic matrix materials, and in particular with various types of mixtures of fibers, for example glass, carbon or natural fibers.

Accordingly, in accordance with a very advantageous further development of the inventive process, as plastic material, a reactive plastic material can be employed, which hardens or cures during or subsequent to roller profiling.

Since the material in the area of the roller profiling is subjected to an elevated temperature as well as an elevated pressure, there results, besides a shaping of the component, also a very good compacting or densification and hardening of the reactive material during or, on the basis of the residual heat remaining in the material, subsequent to the manufacture.

As reactive materials there may be employed duroplastic materials, such as polyester, (epoxy) resins or vinyl esters as well as polyurethanes or the like. These reactive materials are characterized in that they react and cure only after exposure to pressure and temperature, thus during manufacture. As an example, according to one of the embodiments of the process, these plastic materials may be applied for example by spraying, lolling or the like, upon stock or a preform of the fibers which are tumultuous or oriented as a mat, fabric or webbing, knit, paper belt, honeycomb or the like, for reinforcing. According to a supplementary or alternative embodiment, stock or semi-finished parts, in particular mats, fabrics, knits or the like, of the fibers at least partially impregnated or coated with the reactive plastic can be employed.

Besides the manufacture of components of the above mentioned reactive materials, the employment of the inventive process can also be considered advantageous when a thermoplastic material is employed.

Also in the employment for manufacture of components completely or partially of a thermoplastic material, which typically is available economically in large amounts, a very rigid and stable component can be produced by roller profiling at elevated temperatures and by the therewith accomplished densification of the plastic material during manufacture.

A thermoplastic material of this type this can be extruded from the device for supplying as a fiber supplemented plastic mixture.

One such extruding, for example the so-called direct compounding extruding, can occur as a first step of the continuous manufacture of the component directly prior to the roller profiling or, in certain cases and in the case of bringing together of extruded and not extruded starting materials, directly prior to the introduction of a further subcomponent in the device for providing the plastic material. The extruder thereby produces material strands, plates or the like, which are then further processed in the roller profiling into the component. New appropriately controlled extruders with variable material outlet can deliver, to the roller profiling, plates of extruded material varying over time in their width and thickness. The direct compounding offers thereby the advantage, that here already very long fibers can be extruded at the same time, so that subsequent to curing a component with high stability results.

By the compacting and shaping during roller profiling it becomes possible to very rapidly and effectively produce from multiple layers very well-connected sandwich components in diverse shapes. And as reactive plastic material, it could also be considered to apply an adhesive between the individual layers.

According to the inventive process the roller profiling occurs with heated plastic material. The heat can be introduced in various modes and manners depending upon the plastic material, in order to achieve an ideal curing/solidification and deformability of the plastic.

In particular, for thermoplastic materials, there may be considered in accordance with one of the embodiments of the process a warming of the material prior to and, in certain cases, during roller profiling, in order to increase deformability. For reactive materials, in accordance with an alternative embodiment of the process, the heating can occur during and subsequent to roller profiling, in order to improve hardening or curing.

For the warming of the plastic material during the roller profiling it is particularly preferred, in accordance with a second advantageous embodiment of the process of the invention, to use heated rollers as the thermal source or to allow the roller profiling to occur in an area with elevated ambient temperature.

For the heating of the plastic material prior or subsequent to roller profiling the process envisions two advantageous embodiments according to which, as thermal source, either IR-radiation sources are used or the plastic material passes through an area of elevated temperature.

The area of elevated temperature can in ideal manner be combined with the roller profiling occurring in part in such an area. The heated area, which for example can be a convection oven, can already begin prior to the heated part of the roller profiling (for example for thermoplastics) or can extend beyond such (for example for duroplastics) in the device for production of the component.

In one very advantageous embodiment of the inventive idea there is employed, in the roller profiling, at least one roller with a surface structure/profiling, which is imprinted or impressed into the component.

The introduction of the surface structure in the component can serve both for purposes of the optical configuration and/or identification as well as the achievement of an elevated stability with reduced material volume, for example by a web structure or the like. By appropriate surface profiling of one or more of the rollers, these can introduce profilings into the component, for example small—by the positioning and in certain cases the movement of the rollers themselves not achievable—radiuses, grooves or the like.

The component produced in the inventive continuous manufacturing process as an endless shape is divided into units following roller profiling by separating or shearing, for example by shearing, laser or water beam cutting, milling, sawing, etc.

According to an alternative embodiment of the invention, the roller profiling can be followed by a three dimensional deformation in a start-stop process.

In one such only quasi-continuous process step, in which the advance is partially stopped by the control, there can occur a, going beyond the above described bending, three dimensional shaping by pressing, embossing or stamping, for example the stamping of crimps or flanges or characteristic marks, by drawing, by forming edges or by stamping, boring or milling, in the manner known for example from sequential connected tools.

It is particularly advantageous when the three dimensional deformation and the separation of the components by separating, for example shearing, are combined, in the start-stop process, into one process step. Thereby costs, time and production space can further be saved.

### BRIEF DESCRIPTION OF THE DRAWINGS

Advantageous embodiments and further developments of the invention can further be seen on the basis of the illustrative embodiment described in the following drawings.

There are shown:

FIG. 1 a schematic representation of a device for carrying out the process according to the invention;

FIG. 2 one conceivable cross-section through a component produced according to the process; and

FIG. 3 an example of a device for preparing or supplying plastic materials.

### DETAILED DESCRIPTION OF THE INVENTION

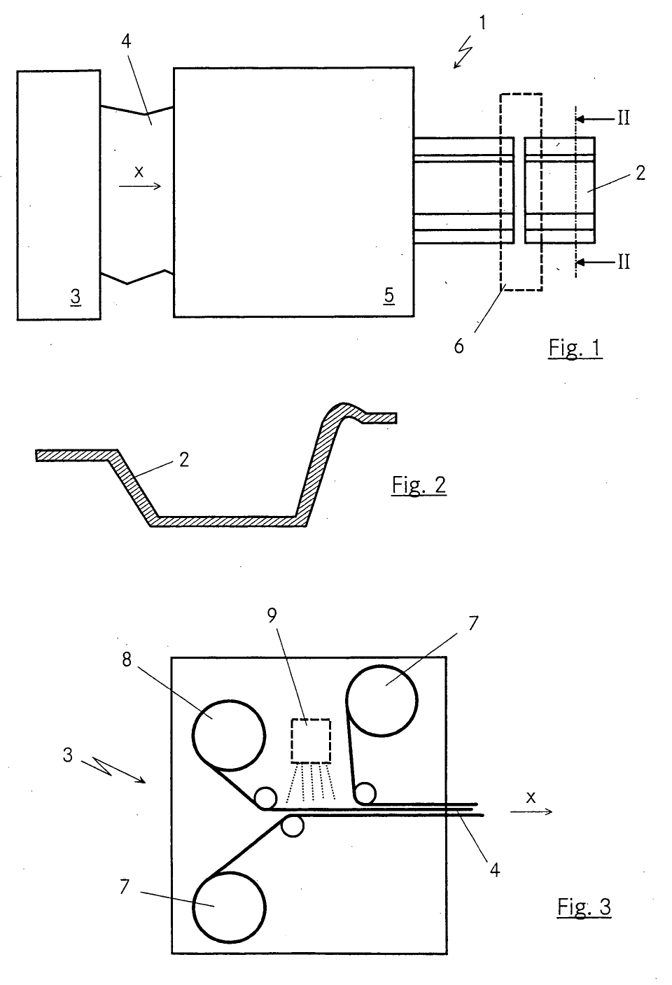

In FIG. 1 an exemplary conceivable device 1 for production of components 2 is illustrated. This device 1 is comprised essentially of a device 3 for providing plastic material 4. Both the device 3 as well as the plastic material 4 could be variously designed or constituted, as will be described later.

Leaving the device 3, the plastic material 4 then reaches a roller profiling 5. The plastic material 4 is deformed there into the component 2 by various rollers, which are changeably controllable in their position and speed for example by CNC. By a roller profiling 5 of this type, which is frequently referred to as roller deforming, various two dimensional or—by a bending in the direction of advance x of the plastic material—three dimensional component shapes can be realized. FIG. 2 shows for example one possible cross section through a conceivable two dimensional shape of such a component 4.

The actual manufacture of the component 2 from the plastic material 4 occurs thus by the compacting and shaping between the rollers of the roller profiling 5. In addition the plastic material 4 is or becomes warmed. Depending upon whether a thermoplastic material or a reactive material, such as for example duroplastic, is employed as the plastic material, in certain cases this warming, as already described above, can occur at various locations during the manufacturing process. By a likewise possible targeted cooling, the temperature of the material can be adjusted independently in a manner ideal for the manufacturing process.

After the component 2 comes out of the roller profiling 5 initially still as an endless shape, it is typically individualized by separating, for example shearing, into the individual components 2 in a separating station 6.

In FIG. 3 one conceivable type of the device 3 for preparing plastic material 4 is schematically represented. The plastic material 4 is to be produced as sandwich material from suitable stock or semi finished product, wherein at least one is of a metallic material. According to the here-illustrated exemplary embodiment, these could for example be two semi-finished products held in advance on rollers 7 of a web of glass or carbon fiber coated with a reactive plastic. These are combined with a third semi finished product of metallic material, which is held ready on a further roll 8.

These three semi-finished products are brought together in the device 3 in known manner to make a sandwich material, wherein an optional coating, here indicated as spray device 9, with a further reactive material and/or an adhesive could occur. Also conceivable is the combination with further layers, for example a paper belt stamped into a web structure. The plastic material 4 combined in the device 3 into a sandwich is then supplied in a conveyor device continuously to the roller profiling 5. Due to the influence of heat, for example by at least several heated rollers, and the compacting occurring by the rollers, the plastic material 4 is then appropriately compacted, shaped and hardened to a finished fiber reinforced component 2.

The plastic or, as the case may be, the fiber reinforced plastic mixture, is therein combined with the metallic material. Thereby there result hybrid components 2, which could be produced for example from a plastic-coated semi-finished product in the shape of a steel sheet metal according to the inventive process.

Therein, reactive hardening as well as thermoplastic materials can be employed, which are brought together with the material of the semi-finished product in the manner of the already described sandwich component or are sprayed there about. The parts then pass through the roller profiling 5, wherein shaping and hardening or curing of the plastic layer(s) occurs. The joining between the materials can therein occur by envelopment, by adhering and/or by introduction of embossments crimps, stamped shapes or the like, which achieve a form locking joint or at least support the adhesive effect via form-fitting complimentary parts. Typical sandwich components could therein be comprised of three layers, wherein plastic between two metal layers can be considered as well as metal surrounded by plastic.

Further alternative embodiments, for similar or different plastic materials 4 and components 2, can be produced based upon the above described embodiment in analogist manner.

1. A process for producing components of a plastic material, in particular a fiber reinforced plastic material, wherein the component beginning with a device for providing plastic material is produced in a continuous manufacturing process by means of roller profiling of the warm plastic material, wherein the plastic material is assembled in the device from multiple different semi finished parts, and wherein there is employed at least one semi finished part of a metallic material, in particular of steel.

2. The process according to claim 1, wherein heat is introduced into the plastic material (4) during roller profiling (5).

3. The process according to claim 1, wherein heat is introduced into the plastic material (4) prior to roller profiling (5).

4. The process according to claim 1, wherein heat is introduced into the plastic material (4) subsequent roller profiling (5).

5. The process according to claim 1, wherein heated rollers are employed as the heat source.

6. The process according to claim 1, wherein IR-emitters are employed as heat source.

7. The process according to claim 1, wherein the plastic material (4) is cooled during the manufacturing process of the component (2).

8. The process according to claim 1, wherein, in the device (3) for providing plastic material (4), different layers (7, 8) are laid superimposed to form a sandwich material.

9. The process according to claim 1, wherein stock material or semi-finished products (7) at least partially impregnated with plastic material or coated, in particular webs, knits or the like, of fiber are employed.

10. The process according to claim 1, wherein as plastic material (4) a reactive plastic material (4) is employed, which cures during or subsequent to roller profiling (5).

11. The process according to claim 1, wherein the plastic material (4) prior to roller profiling (5) is reinforced or made by application (9) of a reactive plastic material (4) upon a semi-finished product (8) of the fibers, in particular web, knit or the like.

12. The process according to claim 1, wherein as the plastic material (4) a thermoplastic material (4) is employed.

13. The process according to claim 1, wherein in the device (3) for providing plastic material (4) a fiber supplemented plastic material mixture is extruded.

14. The process according to claim 1, wherein the semi finished product (7, 8) is cladded with the plastic material.

15. The process according to claim 1, wherein the roller profiling (5) comprises a continuous three dimensional deforming.

16. The process according to claim 1, wherein the components (2) are separated following roller profiling (5) by shearing (6).

17. A process according to claim 1, wherein a three-dimensional deforming of the components (2) in start-stop process follows the roller profiling (5).

18. The process according to claim 17, wherein three-dimensional deforming and a separating of the components (2) by shearing (6) in the start-stop process are combined into a single process step.

19. The process according to claim 1, wherein at least one of the rollers for roller profiling (5) exhibits a surface structure/profiling, which stamps or embosses the component (2).

20. The process according to claim 1, wherein at least some of the rollers during roller profiling (5) are changed, with regard to their speed and their position, by a control device.
